(19) United States
(12) Patent Application Publication
(10) Pub. No.: US 2019/0317955 A1
(43) Pub. Date: Oct. 17, 2019

(54) DETERMINING MISSING CONTENT IN A DATABASE

(71) Applicant: Babylon Partners Limited, London (GB)

(72) Inventors: Vitalii ZHELEZNIAK, London (GB); Daniel William BUSBRIDGE, London (GB); April Tuesday SHEN, London (GB); Samuel Laurence SMITH, London (GB); Nils HAMMERLA, London (GB)

(21) Appl. No.: 16/389,877

(22) Filed: Apr. 19, 2019

Related U.S. Application Data
(63) Continuation of application No. 16/113,670, filed on Aug. 27, 2018.

(30) Foreign Application Priority Data
Oct. 27, 2017 (GB) 1717751.0

(51) Int. Cl. G06F 16/33; G06F 16/338

(52) U.S. Cl. CPC G06F 16/3344; G06F 16/3347; G06F 16/338

(57) ABSTRACT

Computer-implemented methods for determining missing content in a database are provided. The database may contain a plurality of known embedded sentences and their relationship to content. In one aspect, a method includes receiving new queries and generating new embedded sentences from said new queries. The method also includes determining whether the new embedded sentences are similar to known embedded sentences. The method also includes generating a message indicating that new embedded sentence is not linked to content. Systems are also provided.

### CROSS-REFERENCE TO RELATED APPLICATIONS

The present application claims the benefit of priority under 35 U.S.C. § 120 as a continuation from U.S. patent application Ser. No. 16/113,670, entitled “COMPUTER IMPLEMENTED DETERMINATION METHOD,” filed on Aug. 27, 2018 claiming priority to United Kingdom Patent Application No. 1717751.0 filed on Oct. 27, 2017, the disclosure of which is hereby incorporated by reference in its entirety for all purposes.

### FIELD

Embodiments of the present invention relate to natural language processing and natural language processing for responding to queries from a database.

### BACKGROUND

Chatbots are now becoming commonplace in many fields. However, such systems are not perfect. The ramifications of giving an incorrect answer by a chatbot to a question relating to directions or re-directing a call in an automated computer system are annoying, but unlikely to cause serious distress.

There is a much larger challenge to implement a chatbot in a medical setting as incorrect advice could potentially have disastrous results. For this reason, chatbots that are deployed to give medical information are strictly controlled to give advice that are validated a medical professional. However, a user of a medical chatbot may express their symptoms in many different ways and the validation by a medical professional must be able to cover all inputs. Also, validation by a medical expert is a long process and repeats of the validation process should be minimised.

### BRIEF LIST OF FIGURES

FIG. 1 is a schematic of a system in accordance with an embodiment;

FIG. 2(a) is a schematic of a sentence being converted to a representation in vector space and FIG. 2(b) is a schematic showing sentence embedding and similarity measures in accordance with an embodiment;

FIG. 3 is a schematic of an encoder/decoder architecture in accordance with an embodiment;

FIG. 4 is a schematic of an encoder/decoder architecture in accordance with a further embodiment.

FIG. 5 is a schematic showing how natural language is converted to an embedded sentence;

FIG. 6 is a schematic of a method for content look up;

FIG. 7 is a schematic of a method for content discovery; and

FIG. 8(a) and FIG. 8(b) are plots showing the performance of an RNN encoder and a BOW encoder with different decoders.

### DETAILED DESCRIPTION

In an embodiment, a computer-implemented method for retrieving a response for a natural language query from a database is provided, the database comprising a fixed mapping of responses to saved queries, wherein the saved queries are expressed as embedded sentences, the method comprising receiving a natural language query, generating an embedded sentence from said query, determining the similarity between the embedded sentence derived from the received natural language query and the embedded sentences from said saved queries and retrieving a response for an embedded sentence that is determined to be similar to a saved query.

Keeping the content of a chatbot continually updated requires significant computer resources as there is a need to update the mapping between representations of input sentences and the updated content in the database for the entire database. In the above system, as a user query is processed to determine its similarity to existing queries, it is possible to add data to the database without the need to remap the original data. The databases of critical information, such as medical information, a substantial validation process must take place every time an update to the database is performed which changes any of the existing mappings. However, in the above embodiment, since the mapping is preserved for all existing data, it is only necessary to validate updates if new data is added. Also, in addition to avoiding the extra burden of human verification of the new mapping, the process of updating the database by just adding new data as opposed to remapping all existing data is far less computationally burdensome.

In a further embodiment, the embedded sentence is generated from a natural language query, using a decoding function and an encoding function, wherein in said encoding function, words contained in said natural language query are mapped to a sentence vector and wherein in the decoding function, the context of the natural language query is predicted using the sentence vector.

The similarity between the new query and existing queries can be evaluated in either the output space of the decoder or the output space of the encoder. Depending on the similarity function used, the output space of the decoder or the output space of the encoder may give more accurate results.

The above method may be provided with regularisation. This can be done in a number of ways for example, the use of three decoders where one is used for the current sentence and the other two are used for the neighbouring sentences. However, this self-encoding is just one method. Other methods could be to penalise length of word vector or use a dropout method.

In other embodiments the decoder could use two neighbouring sentences on each side of the current sentence, (i.e., 4 or 5 decoders).

Also, the above configuration allows the system to be configured such that it can automatically detect if users are continually requesting data for which it has no suitable content. Therefore, in a further embodiment, a computer-implemented method for determining missing content in a database is provided, said database containing a plurality of known embedded sentences and their relationship to content, the method further comprising receiving new queries and generating new embedded sentences from said new queries, the method further determining whether the new embedded sentences are similar to known embedded sentences and generating a message indicating that new embedded sentence is not linked to content.

To effect the above, the embedded sentences may be clustered and a message is generated to indicate that more content is required if a cluster of new embedded sentences exceeds a predetermined size.

Further, the above allows the monitoring for new content that is being requested by users without extra computing resources since the monitoring of missing content is an inherent part of the system.

In a further embodiment, a natural language computer-implemented processing method for predicting the context of a sentence is provided, the method comprising receiving a sequence of words, using a decoding function and an encoding function, wherein in said encoding function, words contained in said sequence of words are mapped to a sentence vector and wherein in the decoding function, the context of the sequence of words is predicted using the sentence vector, wherein one of the decoding or encoding function is order-aware and the other of the decoding or encoding functions is order-unaware.

The above embodiment provides a sentence representation that can provide more accurate results without the need to increase computing resources.

In an embodiment, the order aware function may comprise a recurrent neural network and the order unaware function a bag of words model. The encoder and/or decoder may be pre-trained using a general corpus.

In some embodiments an end of sentence string to the received sequence of words, said end of sentence string indicating to the encoder and the decoder the end of the sequence of words.

In a further embodiment, a computer-implemented method for determining missing content in a database is provided. The database may contain a plurality of known embedded sentences and their relationship to content. In one aspect, the method includes receiving new queries and generating new embedded sentences from said new queries. The method also includes determining whether the new embedded sentences are similar to known embedded sentences. The method also includes generating a message indicating that new embedded sentence is not linked to content.

In a further embodiment, a system is provided for determining missing content in a database. The system may include a database containing a plurality of known embedded sentences and their relationship to content. The system also includes a user interface adapted to receive user inputted queries. The system also includes a processor, the processor being adapted to generate new embedded sentences from said new queries. The processor also adapted to determine whether the new embedded sentences are similar to known embedded sentences. The processor also adapted to generate a message indicating that new embedded sentence is not linked to content.

Although the examples provided herein relate to medical data, and the advantages relating to validation are more acute in the medical area, the system can be applied in any natural language setting.

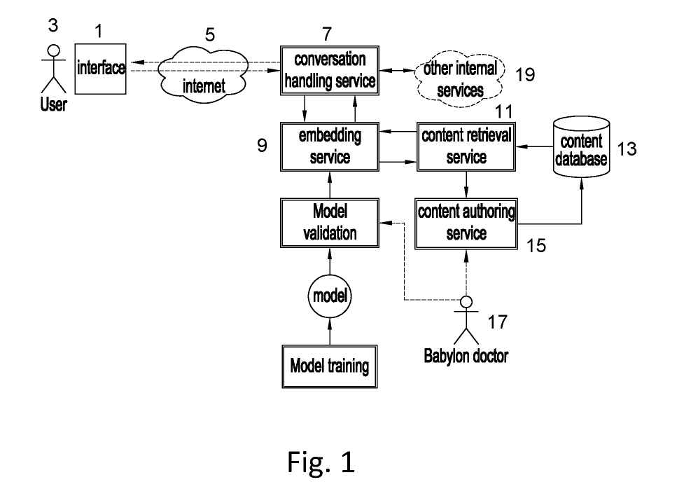

FIG. 1 shows a system in accordance with a first embodiment, the system comprises a user interface 1 for use by a user 3. The user interface 1 may be provided on a mobile phone, the user's computer or other device capable of hosting a web application with a voice input and transmitting a query across the internet.

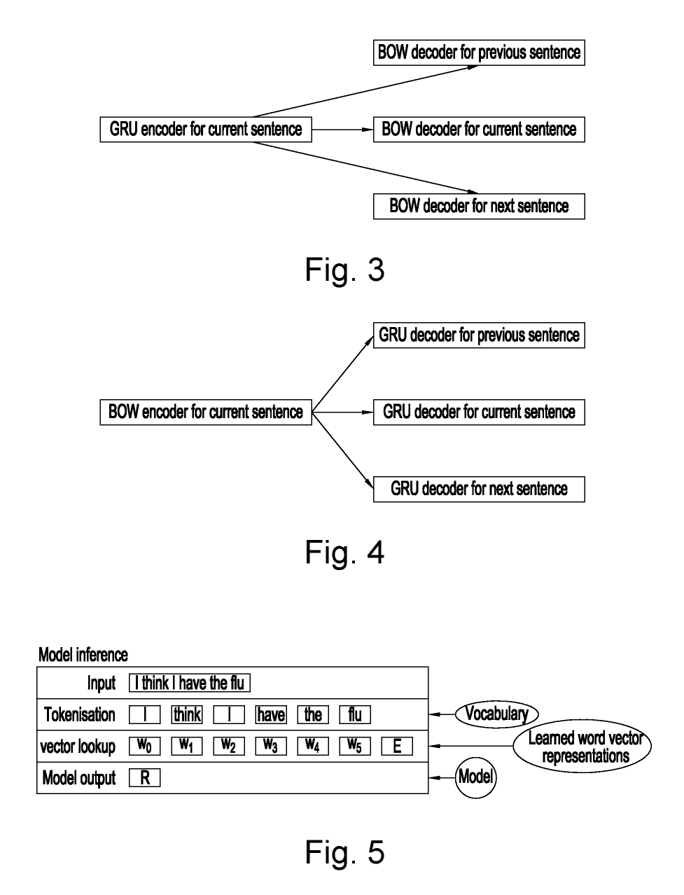

The user 3 inputs a query into the interface and this is transmitted across the internet 5 to a conversation handling device 7. The conversation handling device 7 sends the query to the embedding service 9. The conversation handling device may be provided with simple logic which allows the device for example to direct the user 3 to a human operator if required etc. The embedding service 9 generates a vector representation for the input query. The embedding service will be described in more detail with reference to FIGS. 3 and 4.

The embedding service 9 submits the generated vector representation to a content retrieval service 11. The content retrieval service 11 reads a content database 13 and compares the vector representation of the input query, (which will be referred to hereinafter as the input vector representation) to other vector representations in the database.

In an embodiment, the input vector representation determined to be similar to other vector representations, then content associated with the similar vector representations is passed back to the user 3 via the interface 1, where it is displayed. The content may be directed to the user 3 via the embedding service or may be sent direct to the interface 1.

In a further situation, if no sufficiently similar content is in the content database, the query is passed to the content authoring service 15. The content authoring service groups similar queries into clusters. If the size of a cluster exceeds a threshold, it is determined that content for these similar queries needs to be generated. In an embodiment, this content will be generated by a medical professional 17. Once validated, the new content is added to the content data-base.

After being presented with suitable content (existing or new), the user 3 may select a “call to action” which is submitted to the conversation handling service 7. The conversation handling service may communicate with other internal services (e.g. a diagnostic engine 19) to satisfy the user request.

The above system where a user 3 enters text and a response is returned is a form of chatbot. Next, the details of this chatbot will be described.

When a user enters text into the chatbot, it is necessary to decide how the chatbot should respond. For example, with the above medical system, the chatbot could provide a response indicating which triage category was most appropriate to the user or send the user information that they have requested. Such a system could be designed using a large amount of labelled data and trained in a supervised setup. For example, the dataset detailed in table 1 and build a model ƒ(s) that predicts:

TABLE 1
An example labelled dataset

| Sentence s | Category c |
|---|---|
| Am I pregnant? | pregnancy |
| My foot is huge | feet. |
| . | . |
| . | . |

the probability that the sentence s is about one of the particular categories c (demonstrated in table 2). The functions ƒ(s) that give class probabilities will be called classifier functions.

TABLE 2
An example of probability predictions with classes

| Sentence s | Prob. pregnancy f(s) | Prob. feet f(s)\| |
|---|---|---|
| My foot really hurts | 0.1 | 0.8 |

When building a function ƒ(s) that gives probabilities associated with each content/triage category c:
There needs to be a very large data set like the one detailed in table 1.
Decisions made by medical chatbot need medical validation. Assuming that a classifier function ƒ(s) is created for a limited set of categories {c}, then if a new category is to be added, it would be necessary to create a new classifier function ƒ′(s).
This new classifier function would then need medical validation which is time consuming.

To mitigate the above issues, an unsupervised learning approach is used. Instead of having labels for each sentence, an ordered corpus of sentences (for example, an on-line wiki or set of books is utilized.

Here, instead of building a classifier function that predicts a label given a sentence, an embedding function g(s) is generated from which a sentence's context can be predicted. The context of a sentence is taken to be its meaning. For example, all sentences s that fit between the following sentences:

“The dog was running for the ball.—s—Fluff was everywhere.” can be regarded as similar by a natural language model. Thus, two sentences that have a similar g(s) can be considered similar.

Once g(s), has been determined, it is possible to identify regions of g(s) that correspond to pregnancy or feet, for example. Thus, it is possible to add this content in at particular values of g(s) without changing g(s). This means that new content (and therefore categories) can be added to the chatbot system without updating the statistical model. If the system had been previously medically validated, then now the only components that need medical validation are those queries that would have been initially served one content type and are now served by the new content type.

This significantly reduces medical validation time.

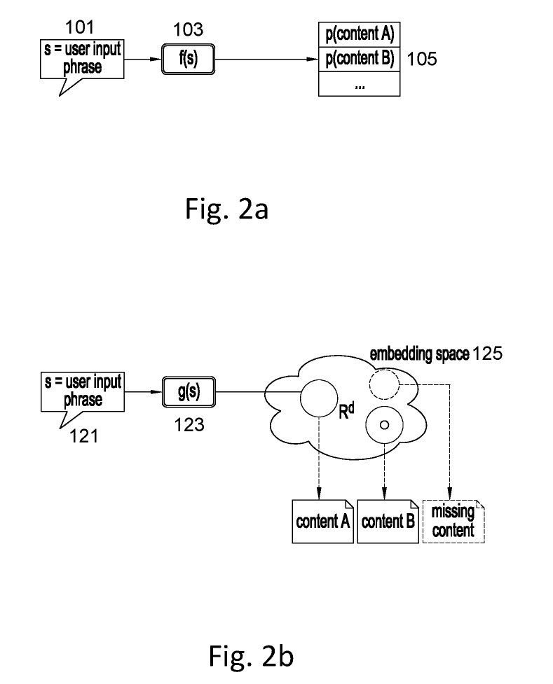

The concepts are shown in FIG. 2. In FIG. 2(a), the user inputs sentence s at 101. This is then converted at 103 to ƒ(s) where ƒ(s) is a representation of the sentence in vector space and this is converted to a probability distribution over the available content in the database 105. If content is added to the database, then ƒ(s) will need to be regenerated for all content and medically re-validated.

FIG. 2(b) shows a method in accordance with an embodiment of the invention. Here, as in FIG. 2(a), the user inputs a phrase as a sentence s. However, sentence s is then converted to embedding function g(s). The embedding functions define a multidimensional embedding space 125. Sentences with similar context will have embedding functions g(s) which cluster together. It is then possible to associate each cluster with content.

In the example shown in FIG. 2(b), a first cluster 127 is linked to content A, a second cluster 129 is linked to content B. Therefore, as in this example, the sentence maps to the first cluster 127, content A is returned as the response.

FIG. 2(b) also shows a further cluster 131 which is not linked to content. This cluster is developed from previous queries where multiple queries have mapped to this particular volume in the embedding space 125 and a cluster has started to form. There is no content for this new cluster. However, the way in which the system is structured allows the lack of content for a cluster to be easily spotted and the gap can be filled. The user input phrase s is embedded through a learnable embedding function g(s) into a high dimensional space. Similar sentences s will obtain similar representations in the high dimensional space. Continuous regions of the high dimensional space can be linked to suitable content. The method can further identify if many input phrases fall into regions where no content is associated, and propose this missing content automatically.

In the above method, the context of a sentence, i.e. the surrounding sentences in a continuous corpus of text, is utilized as a signal during unsupervised learning.

FIG. 3 is a schematic of the architecture used to produce the embedding function g(s) in accordance with an embodiment. The embedding function g(s) will need to perform both a similarity tasks, e.g., to find the most similar embeddings to a given target embedding, and for transfer tasks, where distributed representations learned on a large corpus of text form the initialisation of more complex text-analysis methods, for example an input to a second model that is trained on a separate, supervised task. Such a task could be using a data set of sentences and their associated positive or negative sentiment. The transfer task would then be building a binary classifier to predict sentiment given the sentence embedding.

Before considering the embedding function in more detail, it is useful to consider how sentences are converted to vectors and similarity measures.

Let C=(s₁; s₂, : : : ; sN) be a corpus of ordered, unlabelled sentences where each sentence sᵢ=wᵢ¹ wᵢ² . . . wᵢ^{τ}^{ᵢ} consists of words from a pre defined vocabulary V. Additionally, x_{w} denotes a one-hot encoding of w and v_{w} is the corresponding (input) word embedding. The corpus is then transformed into a set of pairs D={(sᵢ,cᵢ)}ᵢ₌₁^{N}D where s₁∈D and cᵢ is a context of sᵢ. Most of the time it can be assumed that for any sentence si its context ci is given by cᵢ=(sᵢ₋₁; sᵢ₊₁).

In Natural Language processing, semantic similarity has been mapped to cosine similarity, for the purposes of evaluating vector representations' correspondence to human intuitions, where cosine similarity is defined as:

$$Cosine Similarity ( a , b ) = cos ( {θ}_{ab} ) = \frac{a \cdot b}{{‖ a ‖}_{2} {‖ b ‖}_{2}} ,$$

where θ_{ab} is the angle between the two vectors a and b, a b is the Euclidean dot product and ∥a∥₂ is the L2-norm. However, the predominant use of cosine similarity is because early researchers in the field chose this as the relevant metric to optimise in Word2Vec. There is no a priori reason that this should be the only mathematical translation of the human notion of semantic similarity. In truth, any mathematical notion that can be shown to behave analogously to our intuitions about similarity can be used. In particular, in an embodiment, it will be shown that the success of the similarity measure is concerned with the selection of the encoder/decoder architecture.

The construction of a successful sentence embedding is necessarily different to that of its word counterpart, since neither a computer nor a corpus currently exists that would permit learning embeddings for One-Hot (OH) representations of all sentences that are reasonably relevant for any given task. This practical limitation typically results in sentences being constructed as some function of their constituent words. For the avoidance of doubt, an OH representation is taken to mean a vector representation where each word in the vocabulary represents a dimension. To understand the representation of the model shown in FIG. 3, it is useful to understand the FASTSENT model and the Skip Thought model.

Both models and some embodiments of the present invention use an encoder/decoder model. Here, the encoder is used to map a sentence to a vector, the decoder then maps the vector to the context of the sentence.

The FastSent (FS) model will now be briefly described in terms of its encoder, decoder, and objective, followed by a straightforward explanation why this and other log-linear models perform so well on similarity tasks.

Encoder.

A simple bag-of-words (BOW) encoder represents a sentence sᵢ as a sum of the input word embeddings where h is the sentence representation:

$${h}_{i} = {\sum }_{w ∈ {s}_{i}} {v}_{w} . \qquad ( 1 )$$

Decoder.

The decoder outputs a probability distribution over the vocabulary conditional on a sentence sᵢ

$${\hat{y}}_{w} = {p}_{model} ( w \vert {s}_{i} ) = \frac{exp ( {u}_{w} \cdot {h}_{i} )}{{\sum }_{{w}^{′} ∈ V} exp ( {u}_{{m}^{′}} \cdot {h}_{i} )} , \qquad ( 2 )$$

where u∈ [symbol] ^{d} is the output word embedding for a word w. (The biases are omitted for brevity.)

Objective.

The objective is to maximise the model probability of contexts cᵢ given sentences sᵢ across the training set D which amounts to finding the maximum likelihood estimator for the trainable parameters θ.

$${θ}_{MLE} = {argmax}_{θ} {\prod }_{( {s}_{i} , {c}_{i} ) ∈ D} {p}_{model} ( {c}_{i} \vert {s}_{i} ; θ ) \qquad ( 3 )$$

In the log-linear BOW decoder above, the context cᵢ contains words from both and sᵢ₋₁ and sᵢ₊₁ the probabilities of words are independent, yielding

$${p}_{model} ( {c}_{i} \vert {s}_{i} ; θ ) = {\prod }_{w ∈ {c}_{i}} {p}_{model} ( w \vert {s}_{i} ; θ ) = {\prod }_{w ∈ {c}_{i}} \frac{exp ( {u}_{w} \cdot {h}_{i} )}{{\sum }_{{m}^{′} ∈ V} exp ( {u}_{{w}^{′}} \cdot {h}_{i} )} = \frac{{\prod }_{w ∈ {c}_{i}} exp ( {u}_{w} \cdot {h}_{i} )}{\vert {c}_{i} \vert {\sum }_{{w}^{′} ∈ V} exp ( {u}_{{w}^{′}} \cdot {h}_{i} )} . \qquad ( 4 )$$

Switching to the negative log-likelihood, the following optimisation problem is realised:

$${θ}_{MLE} = {argmin}_{θ} [ - {\sum }_{( {s}_{i} , {c}_{i} ) ∈ D} ( {\sum }_{w ∈ {c}_{i}} {u}_{w} \cdot {h}_{i} + \vert {c}_{i} \vert log {\sum }_{{w}^{′} ∈ V} exp ( {u}_{{w}^{′}} \cdot {h}_{i} ) ) ] \qquad ( 5 )$$

Noticing that

$${\sum }_{w ∈ {c}_{i}} {u}_{w} \cdot {h}_{i} = ( {\sum }_{w ∈ c} {u}_{w} ) \cdot {h}_{i} = {c}_{i} \cdot {h}_{i} \qquad ( 6 )$$

the objective (5) forces the sentence representation hᵢ to be similar under dot product to its context representation cᵢ (which is nothing but a sum of the output embeddings of the context words). Simultaneously, output embeddings of words that do not appear in the context of a sentence are forced to be dissimilar to its representation.

Finally, using [symbol] to denote close under cosine similarity, if two sentences sᵢ and sⱼ have similar contexts, then cᵢ [symbol] cⱼ. Additionally, the objective function in (5) ensures that hᵢ [symbol] cᵢ and hⱼ [symbol] cⱼ. Therefore, it follows that hᵢ [symbol] hⱼ.

Putting it differently, sentences that occur in related contexts are assigned representations that are similar under cosine similarity cos (;) and thus cos (;) is a correct similarity measure in the case of log-linear decoders.

However, if the sum encoder above is replaced with any other function, such as a deep or even recurrent neural network, the same results would be achieved. From this it appears that in any model where the decoder is log-linear with respect to the encoder, the space induced by the encoder and equipped with cos (;) as the similarity measure is an optimal distributed representation space: a space in which semantically close concepts (or inputs) are close in distance and that distance is optimal with respect to model's objective.

As a practical corollary, FastSent and related models are among the best on unsupervised similarity tasks because these tasks use cos (;) for similarity and hence evaluate the models in their optimal representation space. Admittedly, evaluating a model in its optimal space does not by itself guarantee any good performance downstream as the tasks might deviate from the model's assumptions. For example, if sentences “my cat likes my dog” and “my dog likes my cat” are labelled as dissimilar, FastSent will stand no chance of succeeding. However, as we show later, evaluating the model in a suboptimal space may very well hurt its performance

In the above FASTSENT model, both the encoder and the decoder process the words of the sentence with no regard to the order of the words. Therefore, both the decoder and the encoder are order-unaware.

Thus, a different embedding cannot be given to the phrases I am pregnant and am I pregnant, however, since they are both clearly about pregnancy, in some situations this should not matter too much. Similarly, the order unaware decoder cannot distinguish between contexts that may be different depending on order (much like the previous pregnancy example). On the other hand, since no ordering information is preserved and there is no sequence information retained (or calculated) in the model, the model has an extremely low memory footprint and is also very fast to train.

In contrast, the skip thought model uses an order-aware embedding function and an order-aware decoding function. The model consists of a recurrent encoder along with two recurrent decoders that effectively predict, word for word, the context of a sentence. While computationally complex it is currently the state-of-the-art model for supervised transfer tasks. Specifically, it uses a gated recurrent unit (GRU).

rₜ=σ(Wᵣv^{t}+Uᵣh^{t-1}), (7)

z^{t}=σ(Wₛv^{t}+U_{z}h^{t-1}), (8)

\tilde{h}^{t}=tan h[Wv^{t}+U(rₜ⊙h^{t-1})], (9)

hₜ=(1−z^{t})⊙h^{t-1}+z^{t}⊙\tilde{h}^{t}, (10)

where ⊙ denotes the element wise (Hadamard) product.

Decoder.

The previous and next sentence decoders are also GRUs. The initial state for both is given by the final state of the encoder

hᵢ₋₁⁰=hᵢ₊₁⁰=hᵢ^{τ}^{ᵢ}. (11)

and the update equations are the same as in eqs. (7) to (10).

Time unrolled states of the previous sentence decoder are converted to probability distributions over the vocabulary conditional on the sentence si and all the previously occurring words

$${( {\hat{y}}_{i - 1}^{t} )}_{w} = {p}_{model} ( {w}_{i - 1}^{t} \vert {w}_{i - 1}^{t - 1} , … , {w}_{i - 1}^{1} , {s}_{i} ; θ ) = \frac{exp ( {u}_{w} \cdot {h}_{i - 1}^{t} )}{{\sum }_{{w}^{′} ∈ V} exp ( {u}_{{w}^{′}} \cdot {h}_{i - 1}^{t} )} , \qquad ( 12 )$$

The outputs ŷᵢ₊₁^{t} of the next sentence decoder are computed analogously

Objective.

The probability of a context cᵢ given a sentence sᵢ is defined as:

$$\begin{matrix} {p}_{model} ( {c}_{i} \vert {s}_{i} ; θ ) = {p}_{model} ( {s}_{i - 1} \vert {s}_{i} ; θ ) \times {p}_{model} ( {s}_{i + 1} \vert {s}_{i} ; θ ) . \\ where & ( 13 ) \\ {p}_{model} ( {s}_{i - 1} \vert {s}_{i} ; θ ) = {\prod }_{t = 1}^{{τ}_{i - 1}} p ( {w}_{i - 1}^{t} \vert {s}_{i} ; θ ) = {\prod }_{t = 1}^{{τ}_{i - 1}} \frac{exp ( {u}_{{w}_{t - 1}^{t}} \cdot {h}_{i - 1}^{t} )}{{\sum }_{{w}^{′} ∈ V} exp ( {u}_{{w}^{′}} \cdot {h}_{i - 1}^{t} )} & ( 14 )\end{matrix}$$

and similarly for p_{model}(sᵢ₊₁|sᵢ; θ).

The MLE for θ can be found as

$${θ}_{MLE} = {argmin}_{θ} [ - {\sum }_{{s}_{i} ∈ C} {\sum }_{j ∈ \{ i - 1 , i + 1 \}} {\sum }_{t = 1}^{{τ}_{j}} ( {u}_{{w}_{j}^{t}} \cdot {h}_{j}^{t} + log {\sum }_{{w}^{′} ∈ V} exp ( {u}_{{w}^{′}} \cdot {h}_{j}^{t} ) ) ] \qquad ( 15 )$$

Using ⊕ to denote vector concatenation and noticing that

$${\sum }_{j ∈ \{ i - 1 , i + 1 \}} {\sum }_{t = 1}^{{τ}_{j}} {u}_{{w}_{j}^{t}} \cdot {h}_{j}^{t} = ( {⊕}_{j ∈ \{ i - 1 , i + 1 \}} {{⊕}_{t = 1}}^{{τ}_{j}} {u}_{{w}_{j}^{t}} ) \cdot ( {⊕}_{j ∈ \{ i - 1 , i + 1 \}} {{⊕}_{t = 1}}^{{τ}_{j}} {h}_{j}^{t} ) = {c}_{i} \cdot {h}_{i}^{𝒟} \qquad ( 16 )$$

the sentence representation [symbol] is now an ordered concatenation of the hidden states of both decoders. As before, [symbol] is forced to be similar under dot product to the context representation cᵢ (which in this case is an ordered concatenation of the output embeddings of the context words). Similarly, [symbol] is made dissimilar with sequences of u_{w}, that do not appear in the context.

The “transitivity” argument above remains intact, except the decoder hidden state sequences might differ in length from sentence to sentence. To avoid this problem, they can be formally treated as infinite dimensional vectors in l² with only a finite number of initial components occupied by the sequence and the rest set to zero. Alternatively, we can agree on the maximum sequence length (which can be derived from the corpus).

Regardless, the above space (of unrolled concatenated decoder states) equipped with cosine similarity is the optimal representation space for models with recurrent decoders. Consequently, this space may be a much better candidate for unsupervised similarity tasks.

In practice, models such as SkipThought are evaluated in the space induced by the encoder (the encoder output space), where cosine similarity is not an optimal measure with respect to the objective. By using [symbol] to denote the decoder part of the model, the encoder space equipped with a new similarity cos ( [symbol] (·), [symbol] (·)) is again an optimal space. While the above is a change of notation, it shows that a model may have many optimal spaces and they can be constructed using the layers of the network itself.

However, concatenating hidden states of the decoder leads to very high dimensional vectors, which might be undesirable for some applications.

Thus, in an embodiment hidden states can be averaged and this actually improves the results slightly. Intuitively, this corresponds to destroying word order information the model has learned. The performance gain might be due to the nature of the downstream tasks. Additionally, because of the way in which the decoders are unrolled during inference time, the “softmax drifting effect” can be observed which causes a drop in performance for longer sequences.

As noted above, FIG. 3 shows an architecture in accordance with an embodiment. Here, a GRU encoder is used to produce a current sentence representation. From this, decoding is performed using the BOW decoder of FS, giving the desired log-linear behaviour without any additional work required to extract the states for the decoder. In this embodiment, the decoder comprises three decoders, one corresponding to the current sentence and one to each of the neighbouring sentences. Although, it is possible for there to be just 2 decoders, one for each of the neighbouring sentences.

In a further embodiment, as shown in FIG. 4, again, one of the encoder or decoder is order aware while the other is order unaware. However, in FIG. 4, the encoder is order unaware and the decoder is order aware.

Referring back to FIG. 1, the details of the operation of the system will be described. First, when an input query is received, it is tokenised as shown in FIG. 5. Next, the vector representation for each word in a dictionary of learned vector representations is looked up and an “end of string” element is added. Finally the model is applied described with reference to FIG. 3 to give representation R.

The end of string element, E, is added so that the system is aware of the end of the phrase. Although the term sentence has been used above, there is no need for sentence to be an exact grammatical sentence, the sentence can be any phrase, for example it can be the equivalent of 3 or 4 sentences connected together or could even be a partial sentence.

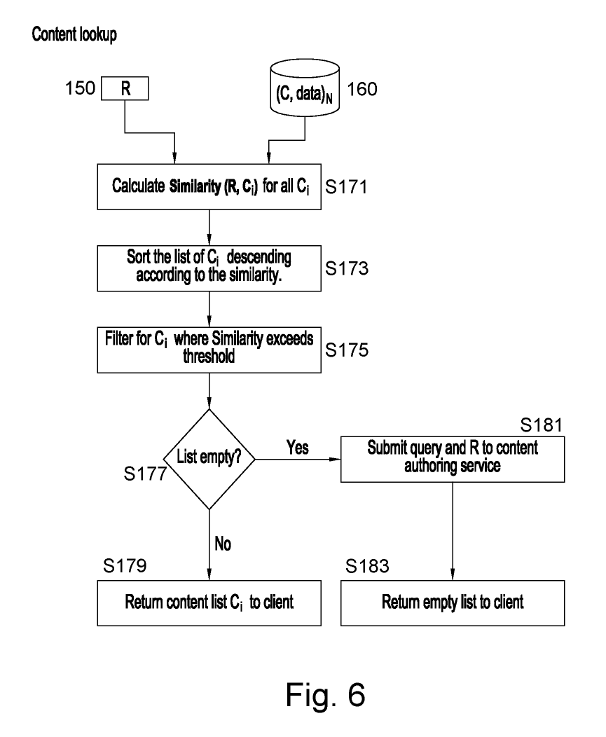

FIG. 6 is a flow diagram showing how the content lookup is performed. The input query R 150 is derived as explained in relation to FIG. 5.

In the content lookup process, data is stored in database 160. The database 160 comprises both content data C and how this maps to regions of the embedded space that was described with reference to FIG. 2(b).

The embedded space shown in FIG. 2(b) as reference numeral 125 can either be the encoder output space of the decoder output space. The encoder output space being the output from the GRU in FIG. 3 where is the decoder output space is the output from the BOW decoder for the current sentence as shown in FIG. 3.

If the encoder output space is used, then the data stored in database 116 needs to map regions of the encoder output space to content. Similarly, if the decoder output space is used, then database 160 needs to hold data concerning the mapping between the content and the decoder output space.

In an embodiment, the decoder output space is used. When the decoder output space is used, the similarity measure described above has been found to be more accurate as the transform to the decoder output space changes the coordinate system to a system that more easily supports the computation of a cosine similarity.

In step S171 a similarity measure is used to determine the similarity or closeness of input query or and regions of the embedded space which map to content in the database 160. As explained above, the cosine similarity can be used, but other similarities may also be used.

The content C₁ is then arranged into a list in step S173 whereby the content is arranged into a list in order of similarity. Next, in step S175, a filter is provided where if the similarity exceeds a threshold, the data is kept.

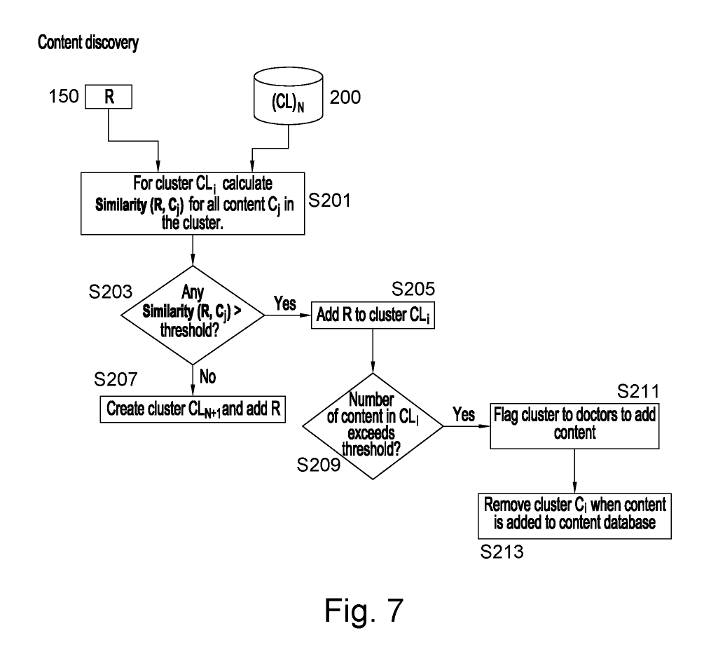

In step S177, a check is then performed to see if the list is empty. If it is not, then the content list is returned to the user in step S179. However, if the list is empty, the method proceeds to step S181. Here, a query is submitted with the input query to a content authoring service that will be described with reference to FIG. 7. Next, in step S183, the empty list is returned to the user.

The ability for the system to easily determine if content that a user has requested is not present allows the system to discover of content missing from the system. The system can automatically identify if many user inputs fall into a region of the high-dimensional embedding space that is not associated with any suitable content. This may be the result of current events that drive users to require information about content not yet supported in the system (e.g. disease outbreaks similar to the Zika virus will trigger many user inputs about this topic). At the moment the discovery of missing content is a fully manual process guided by manual exploration of user inputs as they are recorded by our production system (by a domain expert, e.g. clinician). The proposed system significantly alleviates the required manual intervention and direct the doctors' effort to create content that is currently required by users.

In FIG. 7, new enquiry R 150 is received. Here, the database 200 is a database of clusters. For the avoidance of doubt, cluster is a collection of points which have been determined to be similar in the embedded space. For each cluster, it will be determined in step S201 if the new enquiry R should lie within a cluster. This is done by calculating the similarity as previously explained.

Next, in step 203, if the similarity is greater than a threshold (i.e., the new enquiry is close to previous enquiries which formed a cluster, then the new enquiry is added to an existing cluster in step S205.

If the new enquiry is not similar to any of the previous clusters, a new cluster is created in step S207 and the new enquiry is added to this new cluster.

In step S209, if the new enquiry has been added to an existing cluster in step S205, it is determined in step S209 if the number of points in that cluster exceed a threshold. Since the number of points corresponds to the number of enquiries which are clustering in a specific area in embedded space, this indicates that a number of users are looking for content which the current system cannot provide. If this criteria is satisfied, then in step S211, the cluster is flagged to the doctors for content to be added to the database. Once contented added for the new cluster, the content is added to database 160 (as described with reference to FIG. 6). The cluster is then removed from the cluster database 200 in step S213.

The above example has discussed the formation of clusters. There are many possible methods for clustering vectors. One method for iterative clustering of vectors based on their similarity starts with an empty list of clusters, where a cluster has a single vector describing its location (cluster-vector), and an associated list of sentence vectors. Given a new sentence vector, it's cosine similarity is measured to all the cluster-vectors in the list of clusters. The sentence-vector is added to the list associated with a cluster if the cosine similarity of the sentence-vector to the cluster-vector exceeds a pre-determined threshold. If no cluster-vector fits this criterion a new cluster is added to the list of clusters in which the cluster-vector corresponds to the sentence-vector and the associated list contains the sentence-vector as its only entry.

Other instantiations of this clustering mechanism may add a per-cluster similarity threshold. Both the cluster-vector and the per-cluster similarity threshold then may adapt once a sentence-vector is added to the list of sentence-vectors associated with the cluster, such that the cluster-vector represents the mean of all the sentence vectors associated with the cluster, and such that the similarity threshold is proportional to their variance.

If the number of sentence-vectors within a cluster exceeds a pre-determined threshold it triggers a message to clinicians, instructing them to create content suitable for all the sentences in the list of sentence-vector in the cluster. Once such content is created the cluster is removed from the list of clusters.

In AI based medical diagnostic systems, much effort is expended in validating the model by medical experts. By employing a similarity-based information retrieval approach it is possible to reduce validation to a minimum while guaranteeing sufficient level of clinical safety.

In the above, it has been shown that it is the choice of composition function that determines whether the typical latent representation will be good for a similarity or a transfer task. [symbol] Further, the above described method shows how to extract a representation that is good for similarity tasks, even if the latent representation is not.

[symbol]

To provide experimental validation, several models were trained and evaluated with the same overall architecture but different decoders. In particular SentEval, a standard benchmark, was used to evaluate sentence embeddings for both supervised and unsupervised transfer tasks.

Models and Training.

Each model has an encoder for the current sentence, and decoders for the previous and next sentences. Using the notation ENC-DEC, the following were trained RNN-RNN, RNN-BOW, BOW-BOW, and BOW-RNN. Note that RNN-RNN corresponds to SkipThought, and BOW-BOW to FastSent. In addition, for models that have RNN decoders, between 1 and 10 decoder hidden states were unrolled and the report below is based on the best-performing one (with results for all given in Appendix). These will be referred to as refer to these as *-RNN-concat for the concatenated states and *-RNN-mean for the averaged states. All models are trained on the Toronto Books Corpus, a dataset of 70 million ordered sentences from over 7,000 books. The sentences are pre-processed such that tokens are lower case and splittable on space.

Evaluation Tasks.

The supervised tasks in SentEval include paraphrase identification (MSRP), movie review sentiment (MR), product review sentiment (CR), subjectivity (SUBJ), opinion polarity (MPQA) and question type (TREC). In addition, there are two supervised tasks on the SICK dataset, entailment and relatedness (denoted SICK-E and SICK-R). For the supervised tasks, SentEval trains a logistic regression model with 10-fold crossvalidation using the model's embeddings as features.

The accuracy in the case of the classification tasks, and Pearson correlation with human-provided similarity scores for SICK-R are reported below. The unsupervised similarity tasks are STS12-16, which are scored in the same way as SICK-R but without training a new supervised model; in other words, the embeddings are used to directly compute cosine similarity.

Implementation and hyperparameters. The goal is to study how different decoder types affect the performance of sentence embeddings on various tasks. To this end, we use identical hyperparameters and architecture for each model (except for the encoder and decoder types), allowing for a fair head-to-head comparison. Specifically, for RNN encoders and decoders a single layer GRU with layer normalisation is used. All the weights (including word embeddings) are initialised uniformly over [.0:1; 0:1] and trained with Adam without weight decay or dropout. Sentence length is clipped or zero-padded to 30 tokens and the end-of sentence tokens are used throughout training and evaluation. Avocabulary-size of 20 k, 620-dimensional word embeddings, and 2400 hidden units in RNN encoders/decoders was used.

TABLE 1
Performance on unsupervised similarity tasks. Top section: RNN
encoder. Bottom section: BOW encoder. Best results in each section are shown in bold.
RNN-RNN (SkipThought) has the lowest scores across all tasks. Switching to BOW
decoder (RNN-BOW) leads to significant improvements. However, unrolling the decoder
(RNN-RNN-mean, RNN-RNN-concat) matches the performance of RNN-BOW. In the
bottom section, BOW-RNN-mean matches the performance of BOW-BOW (FastSent).

| Encoder | Decoder | STS12 | STS13 | STS14 | STS15 | STS16 |
|---|---|---|---|---|---|---|
| RNN | BOW | 0.466/0.496 | 0.376/0.414 | 0.478/0.482 | 0.424/0.454 | 0.552/0.586 |
| | RNN | 0.323/0.357 | 0.320/0.319 | 0.345/0.345 | 0.402/0.409 | 0.373/0.408 |
| | RNN-mean | 0.430/0.458 | 0.457/0.446 | 0.499/0.481 | 0.511/0.516 | 0.528/0.542 |
| | RNN-concat | 0.419/0.445 | 0.426/0.414 | 0.466/0.452 | 0.497/0.503 | 0.511/0.529 |
| BOW | BOW | 0.497/0.517 | 0.526/0.520 | 0.576/0.561 | 0.604/0.605 | 0.592/0.592 |
| | RNN | 0.508/0.526 | 0.483/0.489 | 0.575/0.562 | 0.644/0.641 | 0.585/0.585 |
| | RNN-mean | 0.533/0.551 | 0.509/0.517 | 0.578/0.565 | 0.637/0.635 | 0.605/0.601 |
| | RNN-concat | 0.521/0.540 | 0.491/0.498 | 0.561/0.554 | 0.627/0.625 | 0.584/0.581 |

RNN-RNN (SkipThought) has the lowest performance across all tasks because it is not evaluated in the optimal space. Switching to a log-linear BOW decoder (while keeping the RNN encoder) leads to significant gains because RNN-BOW is now evaluated optimally. However, unrolling the decoders of SkipThought (RNN-RNN-*) makes in comparable with RNN-BOW. In the bottom section it can be seen that the unrolled RNN decoder matches the performance of FastSent (BOW-BOW).

TABLE 2
Performance on supervised transfer tasks. Best results in each section are
shown in bold (SICK-R scores for RNN-concat are ommitted due to memory constraints).

| Encoder | Decoder | MR | CR | MPQA | SUBJ | SST | TREC | MRPC | SICK-R | SICK-E |
|---|---|---|---|---|---|---|---|---|---|---|
| RNN | BOW | 75.78 | 79.34 | 86.25 | 90.77 | 81.99 | 84.60 | 70.55 | 0.80 | 78.81 |
| | RNN | 77.06 | 81.77 | 88.59 | 92.56 | 82.65 | 86.60 | 71.94 | 0.83 | 81.10 |
| | RNN-mean | 76.55 | 81.03 | 87.35 | 92.29 | 81.11 | 84.80 | 73.51 | 0.84 | 78.22 |
| | RNN-concat | 76.20 | 82.07 | 85.96 | 91.80 | 80.83 | 87.20 | 71.59 | — | — |
| BOW | BOW | 76.16 | 81.14 | 87.03 | 92.77 | 81.66 | 84.20 | 71.07 | 0.84 | 80.58 |
| | RNN | 76.05 | 82.07 | 85.80 | 92.13 | 80.83 | 87.20 | 72.99 | 0.82 | 78.87 |
| | RNN-mean | 75.85 | 81.30 | 85.54 | 90.80 | 80.12 | 84.00 | 71.13 | 0.81 | 77.76 |
| | RNN-concat | 77.27 | 82.04 | 88.74 | 92.88 | 81.82 | 89.60 | 73.68 | — | — |

The picture in this case is not entirely as clear. It can be seen that deeper models generally perform better but not consistently across all tasks. Curiously, an unusual combination of BOW encoder and RNNconcat decoders leads to the best performance on most benchmarks.

To summarise the results:
Log-linear decoders lead to good results on current unsupervised similarity tasks.
Using the hidden states of RNN decoders (instead of encoder output) may improve the performance dramatically.

Finally, the performance of the unrolled models peaks at around 2-3 hidden states and falls off afterwards. In principle, one might expect the peak to be around the average sentence length of the corpus. One possible explanation of this behaviour is the “softmax drifting effect”. As there is no target sentence during inference time, the word embeddings for the next time step are generated using the softmax output from the previous step, i.e.,

\hat{v}ₜ=V^{T}\hat{p}ₜ₋₁ (17)

where V is the input word embedding matrix. Given the inherent ambiguity about what the surrounding sentences might be, a potentially multimodal softmax output might “drift”” the sequence of \hat{v}ₜ away from the word embeddings expected by the decoder.

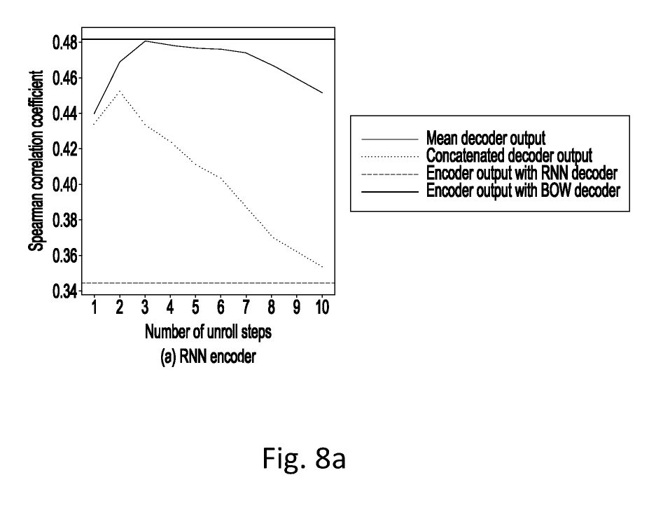

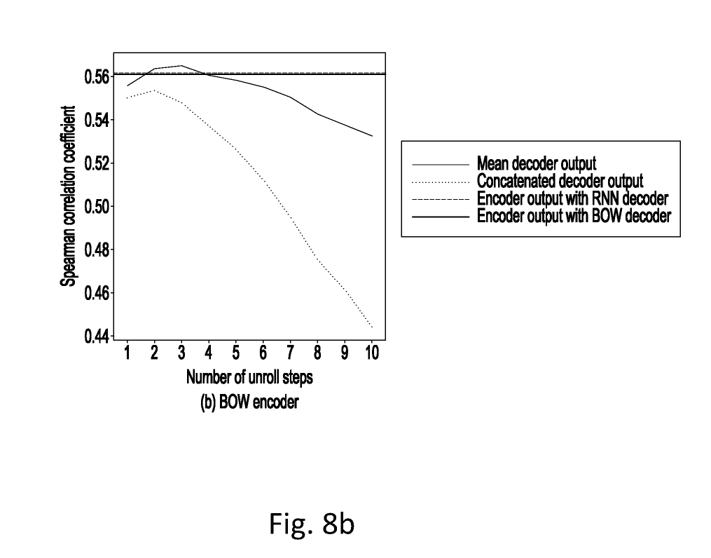

FIGS. 8(a) and 8(b) show performance on the STS14 task depending on a number of unrolled hidden states of the decoders. The results of FIG. 8(a) are for an RNN encoder and 8(b) for a BOW decoder. In case of RNN encoder, RNN-RNN-mean at its peak matches the performance of RNN-BOW and both unrolling strategies strictly outperform RNN-RNN. In case of BOW encoder, only BOW-RNN-mean outperforms competing models (possibly because the BOW encoder is unable to preserve word order information).

The above results show the performance of BOW-BOW and RNN-RNN encoder-decoder architectures when using encoder output as a sentence embedder on unsupervised transfer tasks. Specifically, it has been noted that the encoder-decoder training objective induces a similarity measure between embeddings on an optimal representation space, and that unsupervised transfer performance is maximised when this similarity measure matches the measure used in the unsupervisted transfer task to decide which embeddings are similar.

The results also show better results when the representation space for BOW-BOW is its encoder output, whereas in the RNN-RNN case it is not, but is instead constructed by concatenating the decoder output states. The observed performance gap can then be explained by noting that previous uses of BOW-BOW architectures correctly leverage their optimal representation space, but RNN-RNN architectures have not.

Finally, the preferred RNN-RNN representation space is demonstrated by performing a head-to-head comparison with a RNN-BOW, whose optimal representation space is the encoder output. Unrolling for different sentence lengths gives a performance that interpolates between the lower performance of the RNN-RNN encoder output and the higher performance RNN-BOW encoder output across all Semantic Textual Similarity (STS) tasks.

In the end, a good representation is one that makes a subsequent learning task easier. Specifically, for unsupervised similarity tasks, this essentially relates to how well the model separates objects in the representation space, and how appropriate the similarity metric is for that space. Thus, if a simple architecture is used, with at least one log-linear component connected to the input and output, an adjacent vector representation should be used. However, if a complex architecture is selected, the objective function can be used to reveal, for a given vector representation of choice, an appropriate similarity metric.

While certain embodiments have been described, these embodiments have been presented by way of example only, and are not intended to limit the scope of the inventions. Indeed the novel methods and systems described herein may be embodied in a variety of other forms; furthermore, various omissions, substitutions and changes in the form of methods and systems described herein may be made without departing from the spirit of the inventions. The accompanying claims and their equivalents are intended to cover such forms of modifications as would fall within the scope and spirit of the inventions.

### APPENDIX

The following explains how the quantity in equation 5 is optimised:

$$Q = {\sum }_{( s , c ) ∈ D} {\sum }_{w ∈ c} [ {u}_{w} \cdot {h}_{s} - log {\sum }_{v ∈ {V}_{w}} exp ( {u}_{v} \cdot {h}_{s} ) ] = {\sum }_{( s , c ) ∈ D} {\sum }_{w ∈ {V}_{w}} {q}_{sw} , \\ where$$

$${q}_{sw} = log ( x ) - log ( x + y ) ,$$

the sentence and word subscript on x and y are dropped here for brevity (but in the following equations it is understood that they refer to a specific given word w given specific sentence s), and

$$x = exp ( {u}_{w} \cdot {h}_{s} ) , y = {\sum }_{v ∈ \vert {V}_{w} \vert \backslash \{ w \}} exp ( {u}_{v} \cdot {h}_{s} ) .$$

The below derivatives are found

$$\frac{\partial {q}_{sw}}{\partial x} = \frac{y}{x ( x + y )} , \frac{\partial {q}_{sw}}{\partial y} = - \frac{1}{( x + y )} ,$$

It is therefore concluded that since both x and y are exponents of real values and therefore positive, that for a given word w and sentence s, the quantity q_{sw} is made larger by
(i) Increasing x, leading to an increase in the dot product of the word present in the context with the context vector, and
(ii) Reducing y, leading to a decrease in the the dot products of all other words.
Performing this analysis across all words in a context yields leads to the maximisation of:

$${\sum }_{w ∈ c} {u}_{w} \cdot {h}_{s} = {c}_{s} \cdot {h}_{s} .$$

1. A computer-implemented method for determining missing content in a database, said database containing a plurality of known embedded sentences and their relationship to content, the method comprising:
receiving new queries;
generating new embedded sentences from said new queries;
determining whether the new embedded sentences are similar to known embedded sentences; and
generating a message indicating that new embedded sentence is not linked to content.

2. The computer-implemented method according to claim 1, wherein the embedded sentences are clustered and a message is generated to indicate that more content is required if a cluster of new embedded sentences exceeds a predetermined size.

3. The computer-implemented method according to claim 1, wherein an embedded sentence is generated from a new query using a decoding function and an encoding function, wherein in said encoding function, words contained in said query are mapped to a sentence vector and wherein in the decoding function, the context of the query is predicted using the sentence vector.

4. The computer-implemented method according to claim 3, wherein a similarity between an embedded sentence derived from the new query and the embedded sentences in the database are determined in the embedded sentence space as defined by the output space of the decoder.

5. The computer-implemented method according to claim 3, wherein a similarity between an embedded sentence derived from the new query and the embedded sentences in the database are determined in the embedded sentence space as defined by the output space of the encoder.

6. The computer-implemented method according to claim 3, wherein in the decoding function, comprises at least three decoders, with one decoder for the natural language query and the other two decoders for the neighbouring sentences.

7. The computer-implemented method according to claim 1, wherein the database contains medical information.

8. A non-transitory computer-readable carrier medium comprising computer readable code configured to cause a computer to perform a computer-implemented method for determining missing content in a database, said database containing a plurality of known embedded sentences and their relationship to content, the method comprising:
receiving new queries;
generating new embedded sentences from said new queries;
determining whether the new embedded sentences are similar to known embedded sentences; and
generating a message indicating that new embedded sentence is not linked to content.

9. A system for determining missing content in a database,
the system comprising:
a database containing a plurality of known embedded sentences and their relationship to content,
a user interface adapted to receive user inputted queries; and
a processor, the processor being adapted to:
generate new embedded sentences from said new queries;
determine whether the new embedded sentences are similar to known embedded sentences; and
generate a message indicating that new embedded sentence is not linked to content.

10. The system according to claim 9, wherein the embedded sentences are clustered and a message is generated to indicate that more content is required if a cluster of new embedded sentences exceeds a predetermined size.
